(19) United States
(12) Patent Application Publication
(10) Pub. No.: US 2006/0262677 A1
(43) Pub. Date: Nov. 23, 2006

(54) OPTICAL DISC DRIVE WITH MULTIPLE DISC CAPABILITY

(76) Inventor: Candace Yvette Willrich, Grand Prairie, TX (US)

Correspondence Address: EVERGREEN VALLEY LAW GROUP, 2670 S. WHITE ROAD, SUITE 275, SAN JOSE, CA, 95148, US

(21) Appl. No.: 11/382,028

(22) Filed: May 6, 2006

Related U.S. Application Data
(60) Provisional application No. 60/679,014, filed on May 9, 2005.

(51) Int. Cl. G11B 7/00

(52) U.S. Cl. 369/44.11

(57) ABSTRACT

An optical disc drive includes a housing configured for being installed within or coupled to the computer, either internally or externally. The optical disc drive further includes a plurality of compartments configured for holding a respective plurality of optical discs within the housing. The optical discs may be placed within the compartments in any one of a variety of manners. The optical disc drive includes electronic componentry contained within the housing and configured for reading data from the optical discs and/or writing data to the optical discs. The electronic componentry may include a plurality of channels for simultaneously reading data from the optical discs and/or writing data to the optical discs. The door of the disc drive may contain a mini-digital display for viewing disc contents, titles, annotations, and may have programmable function buttons. The list of files on the optical disc may be browsed via this digital display.

### FIELD OF THE INVENTION

The present inventions generally relate to computers, and in particular, to optical disc drives used in such computers.

### BACKGROUND OF THE INVENTION

Today, almost every computer, including desktop computers and laptop computers, have disc drives capable of reading from, and even writing to, optical discs, such as digital versatile discs (DVDs) and compact disc-read only memory (CD-ROM) discs. These optical disc drives may take the form of internal disc drives, which are capable of being installed within the housing or chassis of the computer, or external disc drives, which are capable of being connected to the computer via an external cable. The use of external disc drives lend themselves well to laptop computers, which have a limited amount of space in their housings for accommodating the variety of input/output devices available to be accessed.

Currently, optical disc drives used in computers are only capable of housing and accessing one optical disc at a time. That is, if a user desires to access multiple optical discs, he or she must insert the first disc into the disc drive, read or write to it, remove it, insert the second disc, and so on. Although desktop computers can typically have two optical disc drives (one DVD drive and one CD drive), they must be purchased and installed within the computer case as separate units. Due mainly to the limited space within their housings, laptop computers currently do not have disc drives capable of accessing multiple optical discs.

There thus remains a need for an improved means for providing multiple optical disc capability to a computer.

### SUMMARY OF THE INVENTION

In accordance with a first aspect of the present inventions, an optical disc drive for use with a computer is provided. The disc drive comprises a housing configured for being installed within or coupled to the computer. For example, the disc drive may be an internal disc drive configured for being installed within the computer, or an external disc drive configured for being coupled to the computer, e.g., via an external cable or via a wireless port using a wireless protocol. The external disc drive can also have a built-in display located somewhere on the housing for browsing disc contents, or can optionally have a digital display on the door of the external disc drive. These techniques can be used with internal disc drives as well.

The optical disc drive further comprises a plurality of compartments configured for holding a respective plurality of optical discs (e.g., CD-ROMs and/or DVDs) within the housing. The optical discs may be placed within the compartments in any one of a variety of manners. For example, the housing may comprise at least one slot, each of which is configured for directly receiving an optical disc into a respective one of the compartments. If the housing comprises a plurality of slots, the optical discs can be respectively received into the slots. If the housing comprises a single slot, the optical discs can be serially received into the slot. As another example, the optical disc drive comprises at least one tray with which the compartments are associated. In this case, the tray(s) is configured for being advanced out of and retracted within the housing. If the optical disc drive comprises a plurality of trays, the compartments may be respectively associated with the trays. If the optical disc drive comprises a single tray, the compartments may be associated with the single tray. For example, the single tray can have two, four, or more compartments.

Lastly, the optical disc drive comprises electronic componentry contained within the housing and configured for reading data from the optical discs and/or writing data to the optical discs on both sides and through multiple disc layers. In one embodiment, the electronic componentry can comprise a plurality of channels for simultaneously reading data from the optical discs and/or writing data to the optical discs. Alternatively, the electronic componentry can comprise a single channel, so that data is read from and/or written to the optical discs one at a time. The electronic componentry can also consist of batteries, hard-drives, microprocessors, or advanced integrated circuits for advanced optical disc drive functionality. The optical disc drive can also have a mini-digital display attached to the exterior cover or door to display disc contents, disc titles, list of files, and other annotations and notes contained on the disc. The door on the mini-digital display can also include function buttons that can be programmed to execute any number of tasks. The display can allow the user to browse through a list of files on the disc.

In accordance with a second aspect of the present inventions, a computer (e.g., a desktop computer, a server, or a portable computer, such as a laptop computer) is provided. The computer comprises a computer case, a central processing unit contained within the computer case, and the optical disc drive described above.

In accordance with a third aspect of the present inventions, an optical disc drive cabinet is provided. The drive cabinet comprises an external housing, and a plurality of compartments configured for holding a respective plurality of optical discs within the housing. The optical discs can be placed in the compartments in the same manner described above, e.g., using one or more slots or trays. The optical disc drive further comprises electronic componentry contained within the housing and configured for reading data from the optical discs and/or writing data to the optical discs. In one embodiment, the electronic componentry can have multiple channels, but alternatively, can have a single channel. The drive cabinet further comprises at least one input/output port coupled to the electronic componentry, and configured for communicating with at least one processing device, such as a computer. The drive cabinet can comprise at least one external cable connected to the input/output port(s), and configured for being physically connected to the processing device(s). Alternatively, each input/output port may comprise a wireless port for communicating with the processing device(s). The drive cabinet can contain integrated displays for viewing disc contents and the use of advanced software applications.

In accordance with a fourth aspect of the present inventions, a computer (e.g., a laptop computer) is provided. The computer comprises a portable computer case, a central processing unit contained within the computer case, and a plurality of compartments configured for holding a respective plurality of optical discs within the housing. The optical discs can be placed in the compartments in the same manner described above, e.g., using one or more slots or trays. The optical disc drive further comprises electronic componentry contained within the housing and configured for reading data from the optical discs and/or writing data to the optical discs. In one embodiment, the electronic componentry can have multiple channels, but alternatively, can have a single channel.

Other objects and features of the present invention will become apparent from consideration of the following description taken in conjunction with the accompanying drawings.

### BRIEF DESCRIPTION OF THE DRAWINGS

The drawings illustrate the design and utility of preferred embodiments of the present invention, in which similar elements are referred to by common reference numerals. In order to better appreciate how the above-recited and other advantages and objects of the present inventions are obtained, a more particular description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 is a perspective view of a desktop computer constructed in accordance with the present inventions;

FIG. 2 is a perspective view of an optical disc drive used in the computer of FIG. 1, particularly showing advancement of the trays from the optical disc drive housing;

FIG. 3 is a perspective view of an optical disc drive used in the computer of FIG. 1, particularly showing retraction of the trays within optical disc drive housing;

FIG. 4 is a top view of one of the trays of FIG. 2;

FIG. 5 is a perspective of another optical disc that can be used in the computer of FIG. 1;

FIG. 6 is a top view of another tray that can be used in the optical disc drive of FIG. 2;

FIG. 7 is a top view of still another tray that can be used in the optical disc drive of FIG. 2;

FIG. 8 is a top view of yet another tray that can be used in the optical disc drive of FIG. 2;

FIG. 9 is a top view of still yet another tray that can be used in the optical disc drive of FIG. 2;

FIG. 10 is a perspective view of another optical disc drive that can be used in the computer of FIG. 1;

FIG. 11 is a perspective view of still another optical disc drive that can be used in the computer of FIG. 1;

FIG. 12 is a perspective view of a laptop computer constructed in accordance with the present inventions;

FIG. 13 is a perspective view of an external optical disc drive constructed in accordance with the present inventions; and

FIG. 14 is a perspective view of an optical disc drive cabinet constructed in accordance with the present inventions.

### DETAILED DESCRIPTION OF THE PREFERRED EMBODIMENTS

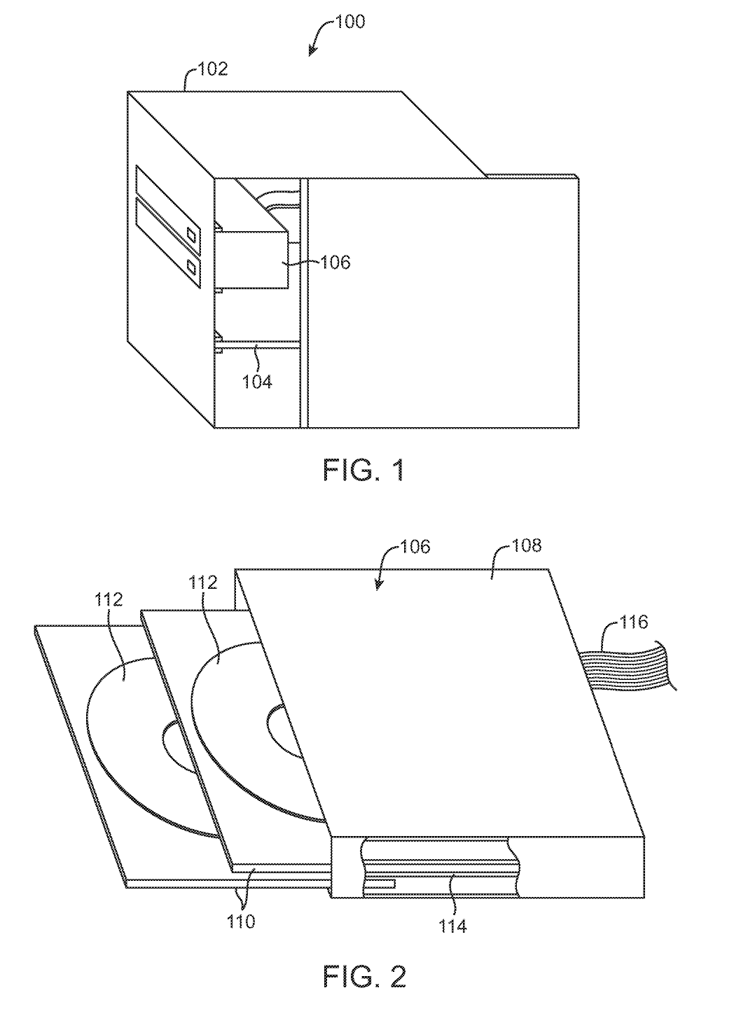

Referring to FIG. 1, an exemplary computer 100 constructed in accordance with the present inventions will be described. In the embodiment illustrated in FIG. 1, the computer 100 takes the form of a desktop computer. As will be described in further detail below, portable computers, such as laptop computers or tablets, can also be constructed in accordance with the present inventions.

The computer 100 is configured for connection to a display, keyboard, and mouse (not shown), and comprises a standard computer case 102 and various computer boards and cards, such as a motherboard 104 (which carries the central processing unit), video cards, input/output boards, etc., contained within the computer case 102. The computer 100 further comprises an internal multi-optical disc drive 106 contained within the computer case 102. The optical disc drive 106 can be installed within the computer case 102 in a standard manner, e.g., via use of screws and/or rails. Alternatively, the optical disc drive 106 can be incorporated on one of the other boards, such as the motherboard 104.

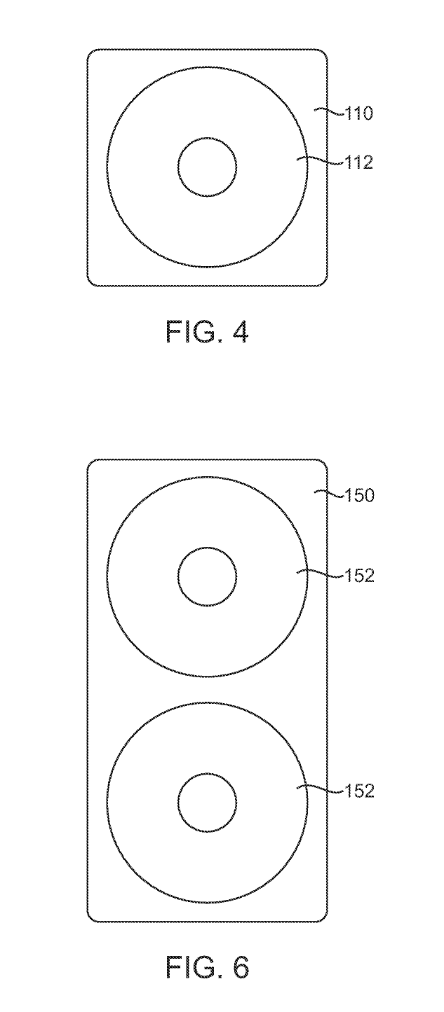

Referring to FIGS. 2-4, the optical disc drive 106 will be described in further detail. The optical disc drive 106 comprises a housing 108, a pair of trays 110, each of which includes a circular compartment 112 for carrying an optical disc, such as a CD-ROM or DVD, electronic componentry 114 for reading data from and/or writing data to the optical discs, and an internal cable 116 for providing power to the electronic componentry 114, and to transmit data between the electronic componentry 114 and other components within the computer 100. The optical disc drive 106 also comprises motors (not shown) operated to spin the optical discs. The circular compartment holds the standard optical disc but can also hold the smaller and odd-sized discs (square or credit-card shaped discs).

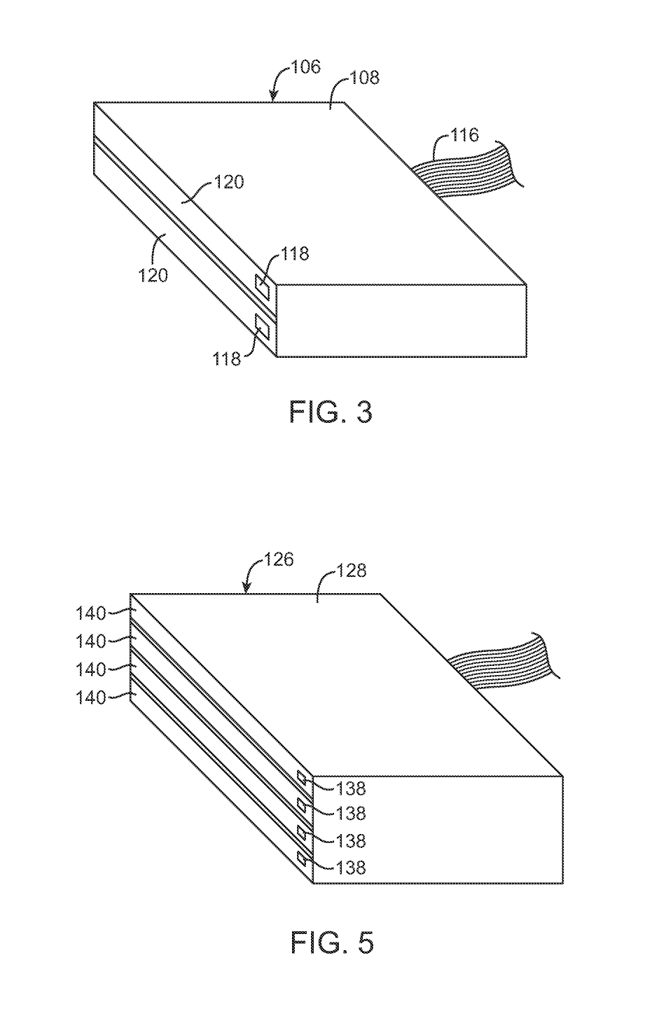

Each of the trays 110 is configured for being advanced out of the housing 108 to allow the optical disc to be placed within or removed from the compartment 112, and retracted within the housing 108 to load the optical disk within the disc drive 106 and allow the optical disc to be accessed by the electronic componentry 114. To this end, the optical disc drive 106 comprises ejection buttons 118 (shown in FIG. 3) that can be depressed to automate advancement/retraction of the trays 110. The ejection buttons can be located in any number of positions on the tray. The optical disc drive 106 may optionally comprise doors 120 (shown in FIG. 3) that enclose the housing 108 when the trays 110 are retracted within the housing 108, and hinge open when the trays 110 are advanced from the housing 108. An optional mini-digital display appears on the door to display disc contents for each compartment. Advanced disc techniques can be made available using the digital display.

The electronic componentry 114 may be formed as a thin technology layer located between the trays 110. In the illustrated embodiment, the electronic componentry 114 has two channels in that it is capable of simultaneously accessing both optical discs, and optionally on both sides of the discs. To this end, the electronic componentry 114 will have at least two sets of laser transmitters, laser readers, etc. The two channels can be closely coupled or separate electronic componentry. Alternatively, the electronic componentry 114 has a single channel in that it is only capable of accessing one optical disc at a time. In either event, the advantages typically associated with having two separate optical disc drives, such as providing a user the ability to access data from two optical discs (e.g., playing music from one optical disc while viewing data from another optical disc, writing data from one optical disc to the other, etc.) is provided in a single unit. In advanced embodiments, the electronic componentry 114 is capable of reading data to and/or writing data to both sides of each optical disc. To minimize thermal issues that may result from the increased size of the electronic componentry 114, fans and/or heatsinks (not shown) may be used to cool the electronic componentry 114. The fan may optionally be configured to be automatically turned on in response to the detection of a heating issue. Optional security locks and latches may be attached or built-into the optical disc drive for locking the exterior of the device or for holding the disk in place inside the unit. The security latch can be controlled by a remote or by a function button located somewhere on the computer housing.

Once the optical discs are loaded into the housing 108, functionality similar to that used for multiple prior art optical disc drives marketed today can be used. For example, each optical disc can be ejected, disabled, searched, retrieved, etc. Indicators (not shown) located on the housing 108 can reveal whether there is a respective optical disc in the housing 108. In addition, a mini-digital display on the exterior door of the optical disc can reveal disc contents, disc title, list of files, annotations, and other disc notes. Other details can be provided such as detailing the number of discs loaded. Software applications can be used to provide these details, or indicator buttons on the housing of the computing device or the optical disc drive can provide disc status to the user. The electronic componentry 114 can be turned on/off for each optical disc by pressing buttons (not shown) located on the housing 108 of the disc drive 106 or anywhere else on the computer 100. The software driver for the optical disc drive 106 can be used to control the volume of the sound emanating from the associated speakers. One volume control button can control the sound associated with both optical discs by using a toggle switch (not shown) that can be actuated to switch between the two optical discs. Intelligent software agents can be used to detect the optical disc whose volume needs to be modified. It is possible to listen to two different optical discs simultaneously, e.g., if the user desired to mix sounds together. The multiple optical disc drive also provides access to unique and advanced software techniques for use with any optical disc loaded such as backup software that allows files to be copied to both optical discs either one at a time or at the same time, visualization software that allows the user to quickly see disc contents and storage capability, annotation software that allows disc files to be annotated and documented, organization software that helps to quickly organize disc contents in a number of formats, and book format software that helps to place disc contents into a book format for simple browsing. In addition, a windowing application can display disc contents, words of the song playing, and special messages loaded on the DVD or CD in the optical disc drive.

The optical disc drive 106 may take advantage of the current technological advancements made today, including read/write speeds, compression, security enhancements, information recall (similar to music CDs) where the computer remembers the last use for the optical discs, and other novel techniques. Software associated with the computer 100 can determine which optical disc to eject, quickly pause one or any of the loaded optical discs, read one optical disc, while writing to the other optical disc, copying/recording data from one optical disc to the other optical disc, place one optical disc in a holding spot for annotations for the other optical disc, etc.

It should be appreciated that although a single optical disc drive 106 has been described as being installed within the computer case 102 to allow a user to access two optical discs, multiple optical disc drives 106 can be installed within the computer case 102 to allow a user to access four or more optical discs. Also, although the optical disc drive 106 is illustrated with two trays 110, an optical disc drive constructed in accordance with the present inventions can have more than two trays to allow a user to access more than two optical discs. For example, FIG. 5 illustrates an optical disc drive 126 comprising a housing 128 and four trays (not shown), each having a compartment for receiving an optical disc, and each configured for being advanced from and retracted within the housing 128. As illustrated, the optical disc drive 126 comprises four doors 140 and associated ejection buttons 138 that operate in the same manner described above with respect to the doors 120 and ejection buttons 118 of the optical disc drive 106 to advance the trays out of the housing 128. The electronic componentry (not shown) can be located on two technology layers, one of which can be placed between the top two trays, and the other of which can be placed between the bottom two trays.

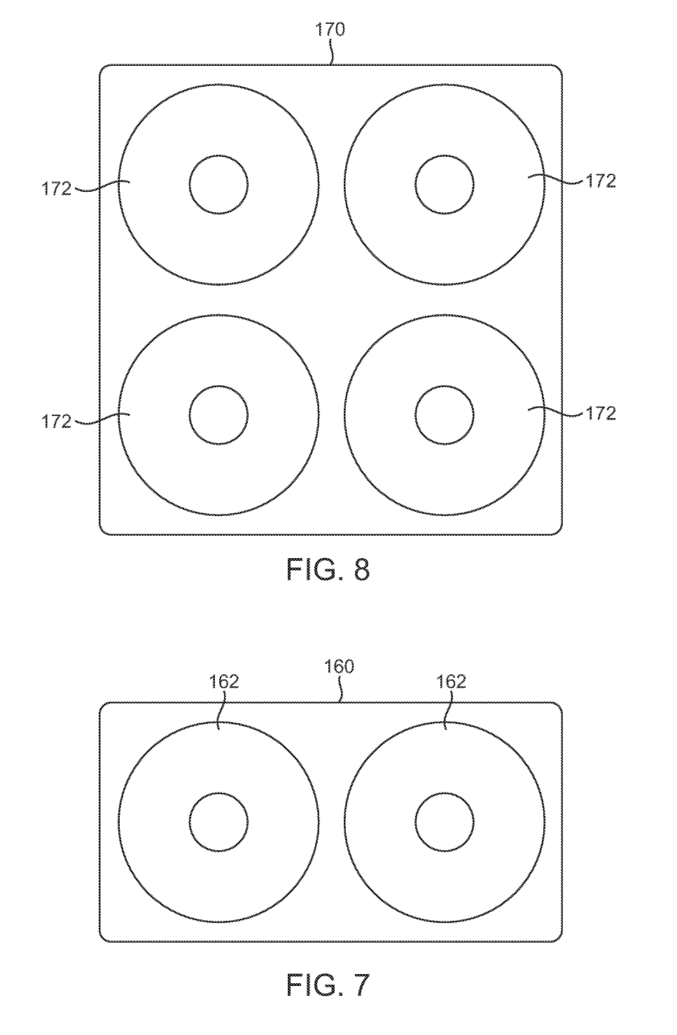

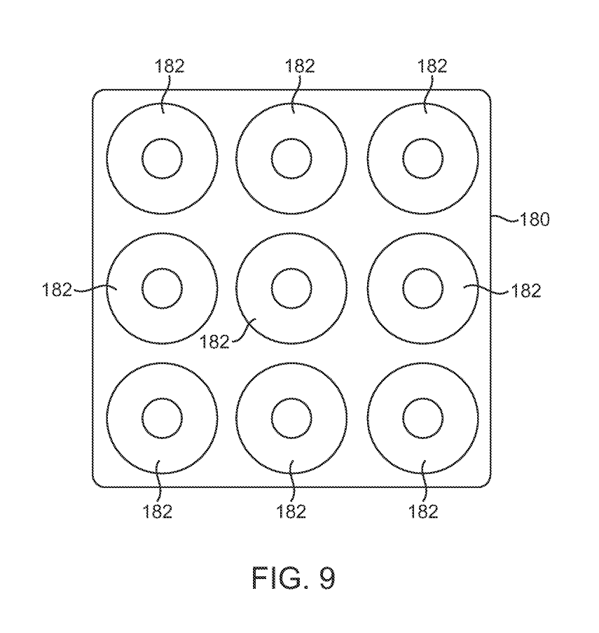

Although the previous optical disc drives have been described as having multiple trays, optical disc drives constructed in accordance with the present inventions can comprise a single tray capable of receiving a plurality of optical discs. For example, FIG. 6 illustrates a tray 150 having two compartments 152 arranged in a tandem relationship, such that the tray 150, when retracted within the associated disc drive housing, extends along the depth of the computer case 102 more than it extends along the width of the computer case 102. FIG. 7 illustrates a tray 160 having two compartments 162 arranged in a side-by-side relationship, such that the tray 160, when retracted within the associated disc drive housing, extends along the width of the computer case 102 more than it extends along the depth of the computer case 102. FIG. 8 illustrates a tray 170 having four compartments 172 arranged in a 2×2 square. FIG. 9 illustrates a tray 180 having nine compartments 182 arranged in a 3×3 square. In this alternative embodiment, the compartments 182 are smaller than the compartments illustrated in FIGS. 6-8. In this case, optical discs smaller than standard optical discs are intended to be placed within the compartments 182.

Although the trays or the slots in the previous embodiments have been described as being installed in a horizontal housing, the trays can also be installed in a vertical housing using any or all of the techniques previously described.

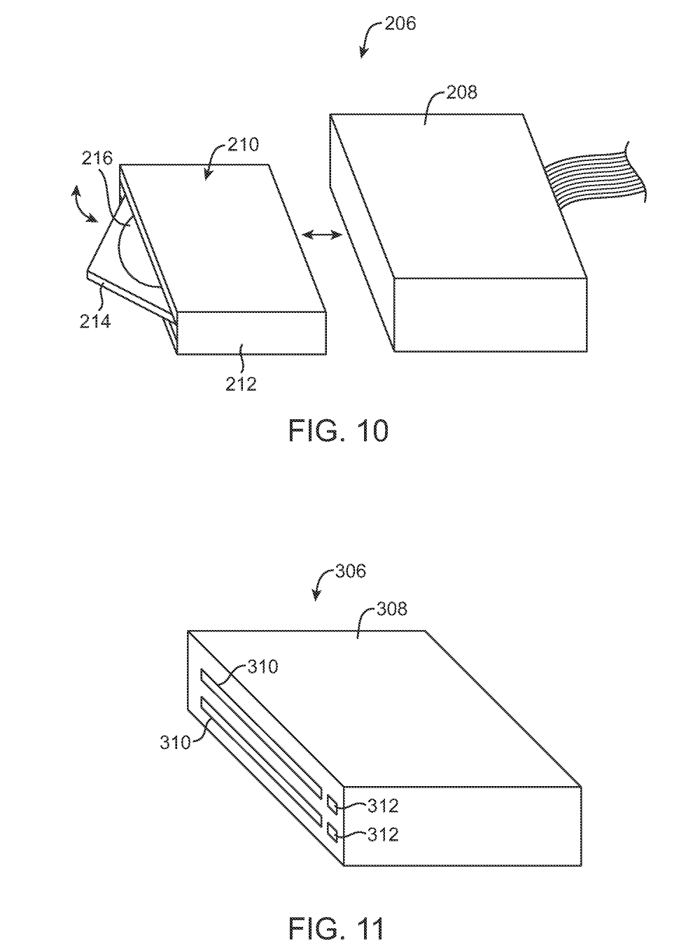

Although the trays in the previous embodiments have been described as being integrated with the optical disc housing, a tray cartridge that can be removed from the housing can be used. For example, FIG. 10 illustrates an optical disc drive 206 that comprises a housing 208 and a removable cartridge 210, which includes a cartridge housing 212 and trays 214 with compartments 216 that swing outward from and inward into the cartridge housing 210 to allow loading of the optical discs into and removal of the optical discs from the cartridge housing 210. Thus, when a user desires to load an optical disc within the disc drive 206, he or she may remove the cartridge 210 from the drive housing 208, swing one of the trays 214 outward from the cartridge housing 212, place the optical disc within the associated compartment 216, swing the tray 214 inward within the cartridge housing 212, and insert cartridge 210 back into the drive housing 208. The optical disc 206 comprises electronic componentry (not shown) for reading data from and/or writing data to the optical discs, which may be incorporated into the drive housing 208. In this case, the electronic componentry for the upper optical disc will be located at the top of the drive housing 208, and the electronic componentry for the lower optical disc will be located at the bottom of the drive housing 208. In this embodiment, the cartridge includes ejection buttons, mini-digital displays, and other visual indicators. The cartridge 210 can still take advantage of the use of trays, compartments, and slots. Advanced techniques include adding additional electronic componentry to the cartridge 210 that allows the cartridge to serve as a stand-alone external DVD/CD device.

Although trays have been described as the means for loading and removing optical discs from the optical disc drive 106, other types of means can be used. For example, FIG. 11 illustrates an optical disc drive 306 that is similar to the previously described optical disc drive 106, with the exception that it comprises a housing 308 with thin slots 310 in which the respective optical discs can be inserted, and from which the optical discs can be extracted in response to the depression of respective buttons 312. One or more optional doors (not shown) can be used to cover the slots 310 in order to prevent debris from entering the housing 308. These doors can slide along the face of the housing 308 to allow access to the slots 310 or may hinge inward inside of the housing 308. Electronic componentry (not shown) can include feeder technology where the optical disc can slide into the drive progressively. Once loaded inside the optical disc drive, the optical disc is locked into place.

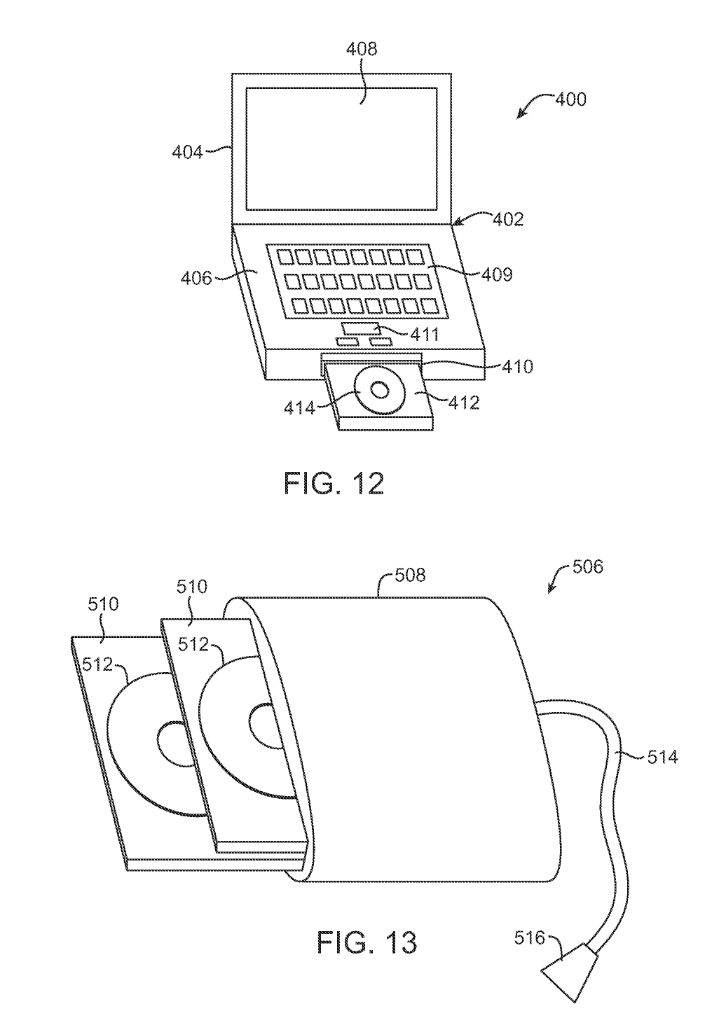

Referring now to FIG. 12, another exemplary computer 400 constructed in accordance with the present inventions will be described. In the embodiment illustrated in FIG. 12, the computer 400 takes the form of a laptop computer. As with typical laptop computers, the computer 400 comprises a computer case 402 that includes top and bottom housings 404, 406, which are closed to effect portability of the computer 400, and opened to allow the user to operate the computer 400. The computer 400 comprises display components, such as a screen 408, which are contained within the top housing 404. The computer 400 also comprises user input components, such as a keyboard 409 and keypad 411 carried by the bottom housing 406, and other typical computer components, such as a central processing unit, video card, input/output card, etc. (not shown) contained within the bottom housing 406. The computer 400 also comprises a multi-optical disc drive 410 contained within the bottom housing 406. In the embodiment illustrated in FIG. 12, the optical disc drive 410 is similar to the optical disc drive 106 illustrated in FIGS. 1-3, with the exception that disc drive 410 is designed to fit within the confines of the laptop housing 406. To this end, the disc drive 410 comprises two trays 412, each one of which has a compartment 414 in which an optical disc can be placed. Thin optical disc slots can be used with this invention.

Although the previous optical discs have been described as being internal, external optical disc drives can be constructed in accordance with the present inventions. For example, FIG. 13 illustrates an external multi-optical disc drive 506, which comprises an external housing 508, a pair of trays 510, each of which includes a circular compartment 512 for carrying an optical disc, such as a CD-ROM or DVD, electronic componentry (not shown) for reading data from and/or writing data to the optical discs, and an external cable 514 for providing power to the electronic componentry, and to transmit data between the electronic componentry and a computer (not shown). The external cable 514 includes a connector 516 configured to be physically connected to an input/output port of the computer. The functionality of the trays 510 and electronic componentry can be the same as the functionality of the trays 110 and electronic componentry 114 described above. It can be appreciated that the use of the external optical disc drive, such as the disc drive 506, provides multiple optical disc reading/writing functionality to a portable computer, such as a laptop computer without having to take up space within the housing of the portable computer. Although not shown, the external disc drive can have wireless ports (and the necessary circuitry) to communicate with processing devices such as computers and many types of electronics. The external disc drive can also include an integrated display and/or a display on the door of each tray or slot. The external drive may optionally include other circuitry, such as microprocessors, hard-drives, flash drives, or advanced integrated circuits.

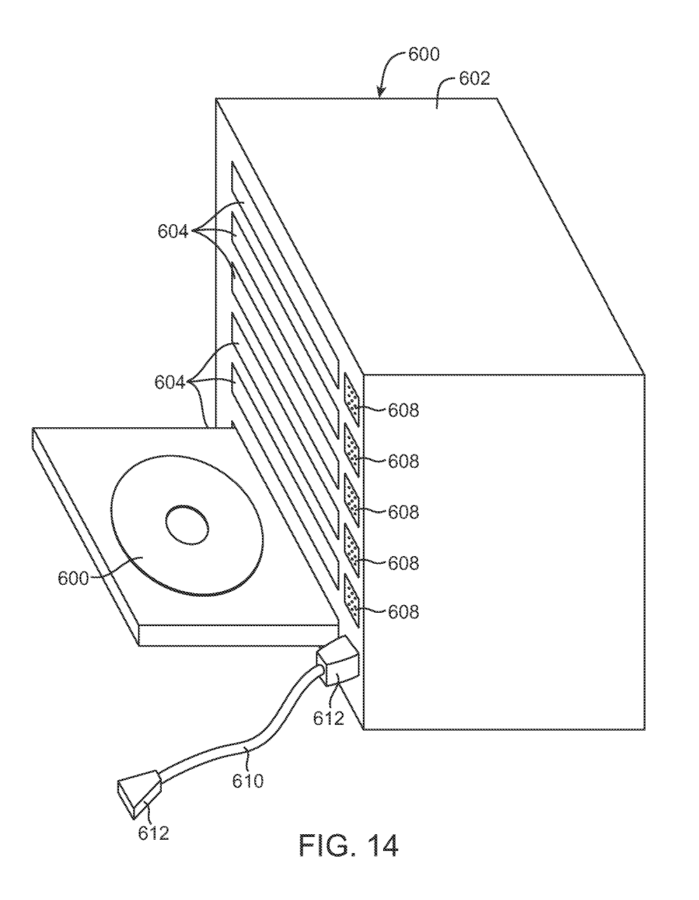

Referring now to FIG. 14, a multi-optical disc drive cabinet 600 constructed in accordance with the present inventions will now be described. The drive cabinet 600 comprises an external housing 602, and a plurality of trays 604 configured for being advanced out of and retracted in the housing 602. In the embodiment illustrated in FIG. 14, each tray 604 comprises a single compartment 606 for placing an optical disc therein. Alternatively, each tray 604 may comprise multiple compartments, such as the trays illustrated in FIGS. 6-9. Alternatively, optical disc cassettes or slots, such as those illustrated in FIGS. 10 and 11 can be used. It should be noted that although six trays 604 are illustrated, the cabinet 600 may include more or less trays than six.

The drive cabinet 600 further comprises electronic componentry (not shown) configured for accessing the optical discs, i.e., reading data from and/or writing data to optical discs contained within the compartments 606 of the trays 604. The electronic componentry preferably has multiple channels, such that it is capable of simultaneously accessing the optical discs. In this case, the electronic componentry has a number of sets of lasers, optical readers, etc. equal to the number of compartments 606. Each set of electronic componentry can be located above or below the respective compartments 606 of the trays 604. The drive cabinet 600 may optionally include other circuitry, such as microprocessors, integrated displays, hard-drives, flash drives, integrated audio capabilities, speakers, built-in headsets, touch displays, remotes, or advanced integrated circuits. The cabinet can have doors with any number of designs and extra compartments for storage. Also, a built-in auto-changer can be added to work in conjunction with the multiple optical disk design.

The drive cabinet 600 further comprises a plurality of input/output ports 608 configured for being electronically coupled to a plurality of respective external processing devices (not shown), so that data can be conveyed between the processing devices and the electronic componentry contained within the cabinet housing 602. In the embodiment illustrated in FIG. 14, external cables 610 are physically connected between the input/output ports 608 of the drive cabinet 600 and the input/output ports (not shown) on the processing devices via connectors 612. In an alternative embodiment, the input/output ports 608 take the form of wireless ports, so that data can be wirelessly transmitted between the processing devices and electronic componentry in the cabinet housing 602. In one embodiment, the processing devices are computers (such as desktop computers, laptop computers, tablets, or even personal digital assistants (PDAs)) although the processing devices may include other types of processing devices, such as CD-ROM or DVD players. Thus, it can be appreciated that the processing devices act as client devices that can access the optical discs contained within the cabinet 600. This cabinet can be used in any number of industries for any number of solutions (data storage, entertainment, education, enterprise).

Optical disc drives are typically used in computing devices such as laptops, desktops, servers, and external devices. The use of internal optical disc drive can be extended to include other devices such as radios, scanners, copiers, printers, monitors, fax machines, cameras, flat displays, displays of a laptop, displays of a tablet, keyboards, telephones, cash register trays, inside of automobiles, water vehicles, and airplanes. Any of these devices can have serial or USB ports for connection with the optical disc. These optical disc drives can use any of the methods described in this document for multiple optical disc drives, or these drives can use a commonly available single optical disc drive. Each of the devices listed above, may need additional circuitry, microprocessors, or advanced integrated circuitry for full optical disc functionality.

In addition, the multiple optical disc technique can be applied to zip drives. Zip drive technology is an alternative data storage technique. Zip drives currently hold one zip disc at a time, and the zip storage disc holds gigs of data. We can appreciate that the novel optical disc techniques mentioned in this document can extend the zip drive art as well. We can also enable any of the newer ultra density storage methods (optical and non-optical) with the multiple optical disc methods described in this document. For instance, UDO discs resemble floppy diskettes. The housing that holds these UDO discs resemble a traditional floppy drive (which can also be enabled with the multiple optical disc method). Thus, it can be appreciated that the novel art described in this document can be applied to any number of storage methods (floppy, zip, UDO, and any others) communicating with a processing device by wirelines or wirelessly.

Some thought has been given to a secondary device (optical disc drive) that can be released from a primary device's housing (computing device (laptops, desktops, external drives) or an electronic device (radio, television, or otherwise)) and used as a portable device. In this case, the secondary device's (optical disc drive) housing contains the necessary circuitry and microprocessors that allow the secondary device to function as a stand-alone device. Optionally, the secondary device (optical disc) can be pulled from the primary device's (computing device) housing and placed in a secondary case. The secondary case has the additional and necessary circuitry to enable the secondary device to function as a stand-alone portable device. A secondary device being pulled from a primary device, and then used as a stand-alone or portable device can be applied to many different types of small electronics. For instance, computers with built-in mp3 players, cellphones, PDAs, and cameras can take advantage of this novel method whereby primary devices have secondary devices built-into its housing.

In the spirit of the present invention, the multiple optical disc drive technique can be applied to a portable DVD/CD player such as the ones provided by many of the electronic manufacturers. Currently, portable DVD/CD players (for movies and music) can only hold one optical disc at a given time. Portable DVD players come with an interior display whereas portable CD players typically do not. Both portable players typically open to reveal two sides. Portable DVD or CD players can take advantage of any of the optical disc methods described in this document. For instance, we can add a traditional optical disc auto-changer to portable DVD or CD players to provide instant access to more than one optical disc in the same housing. Or, we can add an optical disc drive that carries more than one set of disc technology to enable these portable devices to use and access multiple discs simultaneously. Since optical discs are typically placed inside a portable player after opening, we can place optical disc technology on opposite sides of an opened portable DVD or CD device. Thus allowing multiple optical discs to be loaded into a portable DVD or CD device. Or, we can utilize one of the multiple optical disc methods described in this document on only one side of the opened DVD or CD device. Thus, allowing multiple optical discs to be loaded on one side of the opened portable DVD or CD device via a thin slot or a tray. Another improvement to this art is to allow single or multiple optical discs to be loaded while the portable DVD or CD is closed. The optical discs will be loaded through a door that protects the opening from debris. The portable player can also have additional circuitry such as microprocessors, integrated displays, hard-drives, flash drives, and advanced integrated circuitry for advanced functionality.

Another addition to this art includes an optical disc drive capable of holding two smaller CDs or DVDs in the same compartment normally reserved for one regular sized DVD or CD. The compartment allows two smaller discs to be placed inside side by side. When closed, the computing device recognizes that two mini DVDs or two mini CDs are loaded, and behaves accordingly as controlled by the software application. The mini DVDs and CDs can take on any number of shapes and sizes. The tray can also hold two credit-card sized storage cards in the same compartment normally reserved for one regular sized CD or DVD. This tray can still hold a regular sized DVD or CD using a single or multiple optical disc configuration. In this example, the tray has the electronic componentry for reading multiple smaller discs at the same time. This art can be used with internal and external optical disc drives as well as with a portable DVD or CD drive.

As described previously, optical disc drives for smaller CDs and DVDs can be installed into computers such as servers, laptops, or desktops. These optical disc drives can use similar techniques as described in this document—multiple slots, multiple trays, or multiple compartments. These optical disc drives for smaller discs can be installed in an external optical disc drive as well as in a portable optical disc device such as a portable DVD/CD player or a PDA. As technological advances occur, we expect that discs similar to DVDs will be smaller and capable of holding gigs and gigs of data. For instance, a optical disc movie card (shaped like a credit-card) can be used instead of a circular optical disc.

Another novel technique (for internal optical disc drives and multiple optical disc drives for computers) is for these drives to operate without the need for a computer's electrical and computing power. This means that there is sufficient battery power on the optical disc device itself or on the board of the computer to operate the optical disc, thus allowing the user to listen to a DVD or a CD without turning the laptop or desktop on. This optical disc described in this instance includes the extra circuitry needed including integrated circuits, batteries, and microprocessors so that the optical disc can operate and function as a stand-alone device. This extra circuitry is associated with the board of the computing device and/or the optical disc itself.

An alternative for an external optical disc drive (operating by wirelines or wirelessly with a processing device such as a computer) is an external optical disc case that opens like a book. When opened, at least 2 single or multiple optical disc drives are revealed allowing a disc to be loaded in any of the available trays, slots, or compartments. Any of the discs and drives can be operated, controlled, and accessed via a computer or via control buttons located anywhere on the external disc case. When closed, any of the discs loaded in the external disc case can be accessed, viewed, written to, manipulated, or ejected. The discs can also be loaded while the external disc case is closed. This case can have additional “pages” of additional optical disc drives similar to pages in a binder. This external disc case contains the necessary electronic componentry for operation including wires, cables, integrated circuits, microprocessors, displays, integrated displays, USB ports, and serial ports. It can be appreciated that this external optical disc case can take on many different designs and configurations such as a design with a clear covering that allows the disc to be seen as it spins. The external case includes latches and security locks. Any of the external optical drives can take advantage of “on board” software application (software loaded with the circuitry of the device).

Even still, we can design an external optical disc case that takes on a spherical shape with many spherically shaped optical disc slots. The optical discs can be loaded into the external case through an archway rather than through the traditional horizontal opening. The arch opening can close to contain the optical disc and to protect the disc and drive from debris. Furthermore, the area outside the disc area can contain a digital display to display disc contents, titles, and other disc information. A security latch or lock can be added to this design to secure the discs. Many different configurations and designs are possible for this spherical external optical disc case.

Any of the external optical disc devices can optionally contain a rack, shelf, or a compartment to hold optical disc cases or optical discs for later use. This rack or compartment can be attached or detachable from the housing of the external optical disc drive. The compartment can be designed similarly to a drawer that can be opened and closed to hold optical discs and optical disc cases. One of the objectives is to design an optical disc device with a compartment that sits elegantly on the desktop near the computer or portable computer to provide immediate access to a group of DVD/CDs (data, music, movies, or otherwise). Since the external optical disc drive communicates seamlessly with the processing device such as the computer, the user's computer always know which discs are loaded.

Another design enhancements to the multiple optical disc drive for portable devices such as laptops, tablets, or portable electronics is to enable the devices with at least two-side entryways. This means that there are two entry slots on two different sides of the computing or electronic device. For instance, on a portable laptop, the bottom right corner of the device typically holds an optical disc drive with one entryway on the side of the keyboard. Another entryway to the optical disc drive can be added perpendicular to the original optical disc drive using some of the same methods described in this document. External optical disc drives can take advantage of this method—the two entryways can sit on opposites sides with the optical disc's housing sitting in the middle. An advantage of the two entryway optical disc example is that we can add a feeder to the external optical device that allows multiple optical discs (one after another) to be fed through one entryway and out the other entryway. This can be used for backup purposes, creating duplicate copies on optical discs, playing a 2-disc movie, or playing music from CDs. The feeder can include a tray that sits below the optical drive. The feeder allows stacks of optical discs to be fed through the entryways. Advanced designs include adding multiple auto-changers to an optical disc drive (internal and external). This enables a small enterprise to backup their entire network using optical disc technology. These auto-changers can be associated with one drive or with multiple optical disc drives.

Many additional designs methods can be described for this invention from the way the optical discs are loaded to the manner in which the trays and or compartments can be accessed. The external optical drives (as described) can take on many shapes and designs. The external drive can be designed such that the optical discs are loaded into the housing similar to loading bread into a toaster with a mini digital display on the exterior of the housing or with a full integrated display to view disc contents. In addition, the external optical drive can stand upright (as described above) in a stair step or tiered manner.

The multiple optical disc drive can be accessed by the operating system using the same method as a single optical disc drive is accessed. When viewing the contents through a software application, both optical discs are seen as two different drives. Both drives can be accessed simultaneously by the same or different software. The optical discs will also use plug & play technology.

The circuitry needed for the multiple optical disc drive can include an integrated circuit that allows the motherboard to use and take advantage of the multiple optical disc drive. This circuitry allows the dual optical drives to appear and operate as two single independent drives, or it allows both optical drives to appear closely coupled. The closely coupled technology can be used with two single independently installed optical drives in a desktop or a server. The cable or tape from an optical disc (internal drive) to the motherboard may require changes so that multiple optical drives are recognized. The optical disc's serial port from a laptop to its motherboard may require advanced circuitry for the two optical drives to operate independently.

The bios of the computing device may be affected and will require changes to the motherboard's software.

The body of the tray can take on any number of shapes and configurations. One design includes an optical disc enclosure (square, circular, or otherwise) that can cover the entire optical disc on both sides once inserted. The optical disc slides into the enclosure, and then can be read and written to/from. The enclosure contains the necessary electronics componentry for disc access and manipulation. Other electronic componentry can be contained inside of the optical disc housing. Two or more enclosures can be arranged back to back to hold two or more optical discs. The enclosure can be made up of any number of materials (plastic, clear glass-like). New read/write methods can be included to read the entire disc or multiple lines of data simultaneously. Readers can be any number of shapes (circular, square, small, or large), and can read/write to any number of positions on the optical disc simultaneously.

Although particular embodiments of the present invention have been shown and described, it will be understood that it is not intended to limit the present invention to the preferred embodiments, and it will be obvious to those skilled in the art that various changes and modifications may be made without departing from the spirit and scope of the present invention. Thus, the present inventions are intended to cover alternatives, modifications, and equivalents, which may be included within the spirit and scope of the present invention as defined by the claims.

What is claimed is:

1. An optical disc drive for use with a computer, comprising:
a housing configured to be installed within or coupled to the computer;
a plurality of compartments configured for holding a respective plurality of optical discs within the housing; and
electronic componentry contained within the housing and configured for reading data from the optical discs and/or writing data to the optical discs.

2. The optical disc drive of claim 1, wherein the optical disc drive is an internal disc drive.

3. The optical disc drive of claim 1, wherein the optical disc drive is an external disc drive.

4. The optical disc drive of claim 1, wherein the housing comprises at least one slot, each of which is configured for directly receiving an optical disc into a respective one of the compartments.

5. The optical disc drive of claim 4, wherein the at least one slot comprises a plurality of slots configured for respectively receiving the plurality of optical discs.

6. The optical disc drive of claim 4, wherein the at least one slot comprises a single slot configured for serially receiving the plurality of optical discs.

7. The optical disc drive of claim 1, further comprising at least one tray with which the compartments are associated, the at least one tray configured for being advanced out of and retracted within the housing.

8. The optical disc drive of claim 7, wherein the at least one tray comprises a plurality of trays with which the compartments are respectively associated.

9. The optical disc drive of claim 7, wherein the at least one tray comprises a single tray with which the compartments are associated.

10. The optical disc drive of claim 9, wherein the plurality of compartments comprises only two compartments.

11. The optical disc drive of claim 9, wherein the plurality of compartments comprises at least four compartments.

12. The optical disc drive of claim 1, wherein the electronic componentry comprises a plurality of channels for simultaneously reading data from the optical discs and/or writing data to the optical discs.

13. A computer, comprising:
a computer case;
a central processing unit contained within the computer case; and
the optical disc drive of claim 1.

14. The computer of claim 13, wherein the computer is a desktop computer.

15. The computer of claim 13, wherein the computer is a portable computer.

16. The computer of claim 15, wherein the portable computer is a laptop or tablet computer.

17. An optical disc drive cabinet, comprising:
an external housing;
a plurality of compartments configured for holding a respective plurality of optical discs within the housing;
electronic componentry contained within the housing and configured for reading data from the optical discs and/or writing data to the optical discs; and
at least one input/output port coupled to the electronic componentry, said at least one input/output port configured for communicating with at least one external processing device.

18. The optical disc drive cabinet of claim 17, wherein the housing comprises at least one slot, each of which is configured for directly receiving an optical disc into a respective one of the compartments.

19. The optical disc drive cabinet of claim 18, wherein the at least one slot comprises a plurality of slots configured for respectively receiving the plurality of optical discs.

20. The optical disc drive cabinet of claim 18, wherein the at least one slot comprises a single slot configured for serially receiving the plurality of optical discs.

21. The optical disc drive cabinet of claim 17, further comprising at least one tray with which the compartments are associated, the at least one tray configured for being advanced out of and retracted within the housing.

22. The optical disc drive cabinet of claim 21, wherein the at least one tray comprises a plurality of trays with which the compartments are respectively associated.

23. The optical disc drive cabinet of claim 21, wherein the at least one tray comprises a single tray with which the compartments are associated.

24. The optical disc drive cabinet of claim 23, wherein the plurality of compartments comprises only two compartments.

25. The optical disc drive cabinet of claim 23, wherein the plurality of compartments comprises at least four compartments.

26. The optical disc drive cabinet of claim 17, wherein the electronic componentry comprises a plurality of channels for simultaneously reading data from the optical discs and/or writing data to the optical discs.

27. The optical disc drive cabinet of claim 17, comprising at least one external cable connected to the at least one input/output port, said at least one external cable configured for being physically connected to said at least one processing device.

28. The optical disc drive cabinet of claim 17, wherein each of the at least one input/output port is a wireless port.

29. The optical disc drive cabinet of claim 17, wherein the at least one processing device comprises a plurality of processing devices.

30. The optical disc drive cabinet of claim 17, wherein the at least one processing device comprises at least one computer.

31. A computer, comprising:
a portable computer case;
a central processing unit contained within the computer case;
a plurality of compartments configured for holding a respective plurality of optical discs within the housing; and
electronic componentry contained within the housing and configured for reading data from the optical discs and/or writing data to the optical discs.

32. The computer of claim 31, wherein the portable computer is a laptop computer.

33. The computer of claim 31, wherein the computer case comprises at least one slot, each of which is configured for directly receiving an optical disc into a respective one of the compartments.

34. The computer of claim 33, wherein the at least one slot comprises a plurality of slots configured for respectively receiving the plurality of optical discs.

35. The computer of claim 33, wherein the at least one slot comprises a single slot configured for serially receiving the plurality of optical discs.

36. The computer of claim 31, further comprising at least one tray with which the compartments are associated, the at least one tray configured for being advanced out of and retracted within the computer case.

37. The computer of claim 36, wherein the at least one tray comprises a plurality of trays with which the compartments are respectively associated.

38. The computer of claim 36, wherein the at least one tray comprises a single tray with which the compartments are associated.

39. The computer of claim 38, wherein the plurality of compartments comprises only two compartments.

40. The computer of claim 38, wherein the plurality of compartments comprises at least four compartments.

41. The computer of claim 31, wherein the electronic componentry comprises a plurality of channels for simultaneously reading data from the optical discs and/or writing data to the optical discs.
